(19) United States
(12) Patent Application Publication
(10) Pub. No.: US 2025/0370155 A1
(43) Pub. Date: Dec. 4, 2025

(54) EVALUATING SUBSURFACE CONDITIONS

(71) Applicant: Halliburton Energy Services, Inc., Houston, TX (US)

(72) Inventors: Zhijie Sun, Houston, TX (US); Derek Shelby Bale, Houston, TX (US); Yang Yu, Singapore (SG); Ning Tu, Singapore (SG); Zhonghuan Chen, Houston, TX (US)

(73) Assignee: Halliburton Energy Services, Inc., Houston, TX (US)

(21) Appl. No.: 19/039,680

(22) Filed: Jan. 28, 2025

Related U.S. Application Data
(60) Provisional application No. 63/653,300, filed on May 30, 2024.
(60) Provisional application No. 63/654,764, filed on May 31, 2024.

(51) Int. Cl. G01V 1/50; E21B 43/12; G01V 1/28

(52) U.S. Cl. CPC G01V 1/50; E21B 43/12; G01V 1/282; G01V 2210/1429; G01V 2210/44; G01V 2210/646; G01V 2210/675

(57) ABSTRACT

A method and system for evaluating one or more properties of a wellbore. The method may include generating a tube wave in a piping disposed in a wellbore, creating a time-domain forward model with one or more parameters to represent the tube wave in the piping, and transforming the time-domain forward model to model the tube wave as a pressure wave. The method may further include evaluating a loss function of the time-domain forward model and identifying a second set of parameters from the loss function to adjust the one or more parameters.

### CROSS REFERENCE TO RELATED APPLICATIONS

This application claims the priority of U.S. Provisional Patent Application No. 63/653,300, filed May 30, 2024, which is incorporated by reference in its entirety.

### BACKGROUND

Hydrocarbons, such as oil and gas, are commonly obtained from subterranean formations that may be located onshore or offshore. The development of subterranean operations and the processes involved in removing hydrocarbons from a subterranean formation are complex. Subterranean operations involve a number of different steps such as, for example, drilling a wellbore at a desired well site, treating and stimulating the wellbore to optimize production of hydrocarbons, and performing the necessary steps to produce and process the hydrocarbons from the subterranean formation.

This disclosure relates to the field of seismic analysis and hydraulic fracture as well as hydraulic fracturing process monitoring and evaluation. In particular, monitoring hydraulic fracturing, currently, requires a large number of resources to evaluate downhole conditions via pressure pulse technology.

### BRIEF DESCRIPTION OF THE DRAWINGS

These drawings illustrate certain aspects of some examples of the present disclosure and should not be used to limit or define the disclosure.

FIG. 1 is a diagram illustrating an example system for treatment operations, according to aspects of the present disclosure.

FIG. 2 is a diagram illustrating an example pumping system, according to aspects of the present disclosure.

FIG. 3 illustrates a schematic of an information handling system.

FIG. 4 illustrates a schematic of a chip set.

FIG. 5 illustrates a computing network.

FIG. 6 illustrates a neural network.

FIG. 7 illustrates a workflow for modeling a tube wave.

### DETAILED DESCRIPTION

The present disclosure generally relates to systems and methods use flow rate and surface pressure information to properly align and scale a model of a tube wave and select the optimal parameters which maximizes similarity between modeled and measured tube wave.

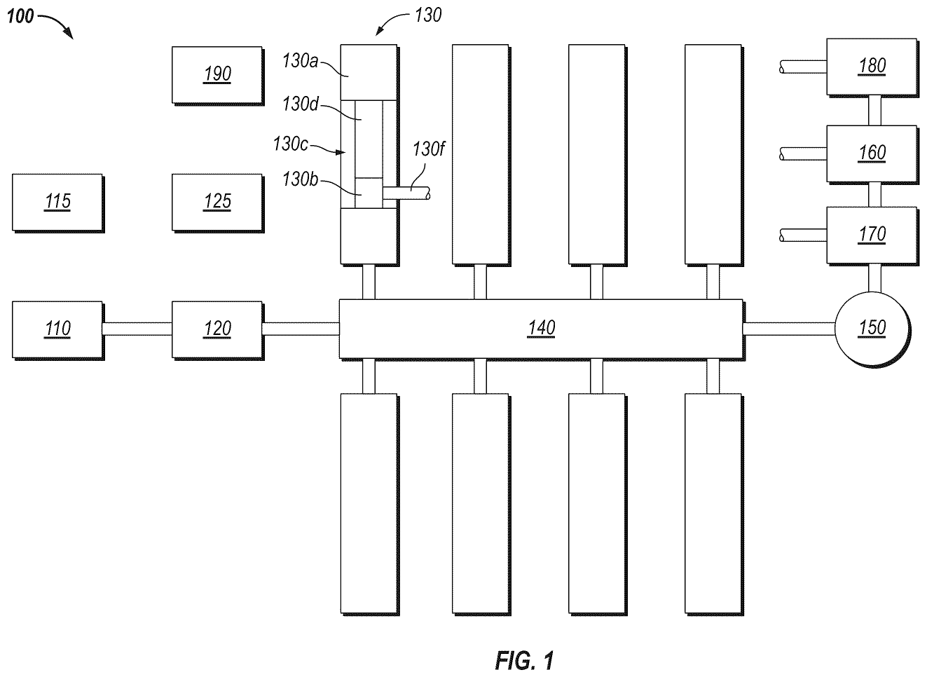

FIG. 1 is a diagram illustrating an example of a frac system 100 for treatment operations, according to aspects of the present disclosure. Frac system 100 may comprise a fluid management system 110 in fluid communication with a blender system 120. Blender system 120 may in turn be in fluid communication with one or more pumping systems 130 through a fluid manifold 140. Fluid manifold 140 may provide fluid communication between pumping systems 130 and a wellbore 150. In use, fluid management system 110 may receive water or another fluid from a fluid source 115 (e.g., a ground water source, a pond, one or more frac tanks), mix one or more fluid additives into the received water or fluid to produce a treatment fluid with a desired fluid characteristic, and provide the produced treatment fluid to blender system 120. Blender system 120 may receive the produced treatment fluid from fluid management system 110 and mix the produced treatment fluid with a proppant, such as sand, or another granular material 125 to produce a final treatment fluid that is directed to fluid manifold 140. Pumping systems 130 may then pressurize the final treatment fluid to generate pressurized final treatment fluid that is directed into wellbore 150, where the pressurized final treatment fluid generates fractures within a formation in fluid communication with wellbore 150.

An example one of pumping systems 130 may comprise a first mover 130 a, a pump 130 b, and a drive train 130 c. As used herein, a mover may comprise any device that converts energy into mechanical energy to drive a pump. Example movers comprise, but are not limited to, electric pump motors, hydrocarbon-driven or steam engines, turbines, etc. Drive train 130 c may be removably coupled to first mover 130 a and pumps 130 b through one or more drive shafts (not shown), and may comprise a transmission 130 d with one or more gears that transmits mechanical energy from first mover to the pump 130 b. For instance, to the extent pumps 130 b comprise reciprocating pumps, the mechanical energy may comprise torque that drives pump 130 b.

Drive train 130 c may further comprise an electric pump motor 130 e. As depicted, the electric pump motor 130 e may be coupled to transmission 130 d between transmission 130 d and pump 130 b. In the embodiment shown, electric pump motor 130 e may receive mechanical energy from first mover 130 a through transmission 130 d and provide the received mechanical energy to pump 130 b augmented by mechanical energy generated by electric pump motor 130 e. It should be appreciated, however, that the orientation of electric pump motor 130 e with respect to first mover 130 a, transmission 130 d, and the pump 130 b is not limited to the embodiment shown. In other embodiments, electric pump motor 130 e may be positioned between transmission 130 d and first mover 130 a, for instance, or between elements of transmission 130 d itself. In yet other embodiments, electric pump motor 130 e may be incorporated into transmission 130 d as part of a hybrid transmission system through which power from both first mover 130 a and electric pump motor 130 e are provided to pump 130 b.

First mover 130 a and electric pump motor 130 e may receive energy or fuel in one or more forms from sources at the wellsite. The energy or fuel may comprise, for instance, hydrocarbon-based fuel, electrical energy, hydraulic energy, thermal energy, etc. The sources of energy or fuel may comprise, for instance, on-site fuel tanks, mobile fuel tanks delivered to the site, electrical generators, hydraulic pumping systems, etc. First mover 130 a and electric pump motor 130 e may then convert the fuel or energy into mechanical energy that may be used to drive associated pump 130 b.

In the embodiment shown, first mover 130 a may comprise an internal combustion engine such as a diesel or dual fuel (e.g., diesel and natural gas) engine and electric pump motor 130 e may comprise an electric pump motor. First mover 130 a may receive a source of fuel from one or more fuel tanks (not shown) that may be located within the pumping system 130 and refilled as necessary using a mobile fuel truck driven on site. Electric pump motor 130 e may be electrically coupled to a source of electricity through a cable 130 f. Example sources of electricity comprise, but are not limited to, an on-site electrical generator, a public utility grid, one or more power storage elements, solar cells, wind turbines, other power sources, or one or more combinations of any of the previously listed sources.

As depicted, the source of electricity coupled electric pump motors 130 e comprises a generator 160 located at the well site. The generator may comprise, for instance, a gas-turbine generator or an internal combustion engine that produces electricity to be consumed or stored on site. In the embodiment shown, generator 160 may receive and utilize natural gas from the wellbore 150 or from another wellbore in the field (i.e., “wellhead gas”) to produce the electricity. As depicted, frac system 100 may comprise gas conditioning systems 170 that may receive the gas from wellbore 150 or another source and condition the gas for use in the generator 160. Example gas conditioning systems comprise, but are not limited to, gas separators, gas dehydrators, gas filters, etc. In other embodiments, conditioned natural gas may be transported to the well site for use by the generator.

Frac system 100 may further comprise one or more energy storage devices 180 that may receive energy generated by generator 160 or other on-site energy sources and store in one or more forms for later use. For instance, energy storage devices 180 may store the electrical energy from generator 160 as electrical, chemical, or mechanical energy, or in any other suitable form. Examples of energy storage devices 180 may comprise, but are not limited to, capacitor banks, batteries, flywheels, pressure tanks, etc. In certain embodiments, energy storage devices 180 and generator 160 may be incorporated into a power grid located on site through which at least some of the fluid management system 110, blender system 120, pumping systems 130, and gas conditioning systems 170 may receive power.

In use, first mover 130 a and electric pump motor 130 e may operate in parallel or in series to pump 130 b, with the division of power between the movers being flexible depending on the application. For instance, in a multi-stage well stimulation operation, the formation may be fractured (or otherwise stimulated) in one or more “stages,” with each stage corresponding to a different location within the formation. Each “stage” may be accompanied by an “active” period during which pump 130 b may be engaged and pressurized fluids are being pumped into wellbore 150 to fracture the formation, and an “inactive” period during which the pumps are not engaged while other ancillary operations are taking place. The transition between the “inactive” and “active” periods may be characterized by a sharp increase in torque requirement.

In an embodiment in which first mover 130 a comprises a diesel engine and electric pump motor 130 e comprises an electric pump motor, both the diesel engine and electric pump motor may be engaged to provide the necessary power, with the percentage contribution of each depending on the period in which frac system 100 is operating. For instance, during the “inactive” and “active” periods in which the torque requirements are relatively stable, the diesel engine, which operates more efficiently during low or near constant speed operations, may provide a higher percentage (or all) of the torque to the pump than the electric pump motor. In contrast, during transitions between “inactive” and “active” states, the electric pump motor may supplant the diesel engine as the primary source of torque to lighten the load on the diesel engine during these transient operations. In both cases, the electric pump motor reduces the torque required by the diesel engine, which reduces the amount of diesel fuel that must be consumed during the well stimulation operation. It should be noted that power sources could be used during continuous operation or intermittently as needed, including during transmission gear-shift events.

In addition to reducing the amount of diesel fuel needed to perform a well stimulation operation, the use of a first mover and an electric pump motor in a pumping system described herein may provide flexibility with respect to the types of movers that may be used. For instance, natural gas engines, i.e., internal combustion engines that use natural gas as their only source of combustion, are typically not used in oil field environments due to their limited torque capacity. By including two movers within pumping system 130, the torque capacity of the natural gas engine may be augmented to allow the use of a natural gas engine within pumping system 130. For instance, in certain embodiments, first mover 130 a may comprise a natural gas engine and electric pump motor 130 e may comprise an electric pump motor that operates in series or parallel with the natural gas engine to provide the necessary torque to power pump 130 b.

In certain embodiments, pumping systems 130 may be electrically coupled to an information handling system 190 that directs the operation of first movers 103 a and electric pump motors 130 e of pumping systems 130. Information handling system 190 may further control at least a part of frac system 100. As illustrated, the information handling system 190 may comprise any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 190 may be a personal computer, a network storage device, or any other suitable device and may vary in size, shape, performance, functionality, and price.

Information handling system 190 may comprise a processing unit (e.g., microprocessor, central processing unit, etc.) that may process data from electric pump motor 130 e, discussed below, by executing software or instructions obtained from a local non-transitory computer readable media (e.g., optical disks, magnetic disks). The non-transitory computer readable media may store software or instructions of the methods described herein. Non-transitory computer readable media may comprise any instrumentality or aggregation of instrumentalities that may retain data and/or instructions for a period of time. Non-transitory computer readable media may comprise, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 190 may also comprise input device(s) (e.g., keyboard, mouse, touchpad, etc.) and output device(s) (e.g., monitor, printer, etc.). The input device(s) and output device(s) provide a user interface that enables an operator to interact with any device disposed or a part of frac system 100 and/or software executed by a processing unit.

For example, information handling system 190 may send one or more control signals to pumping systems 130 to control the speed/torque output of first movers 130 a and electric pump motors 130 e. The control signals may take whatever form is necessary to communicate with the first movers 130 a and electric pump motors 130 e. For example, a control signal to electric pump motor 130 e may comprise an electrical control signal to a variable frequency drive (VFD), discussed below, coupled to electric pump motor 130 e, which may receive the control signal and alter the operation of the electric pump motor based on the control signal.

In certain embodiments, information handling system 190 may also be electrically coupled to other elements of the system, including fluid management system 110, blender system 120, pumping systems 130, generator 160, and gas conditioning systems 170 in order to monitor and/or control the operation of frac system 100. In other embodiments, some or all of the functionality associated with information handling system 190 may be located on the individual elements of the system, e.g., each of pumping systems 130 may have individual controllers that direct the operation of the associated first mover 130 a and electric pump motors 130 e.

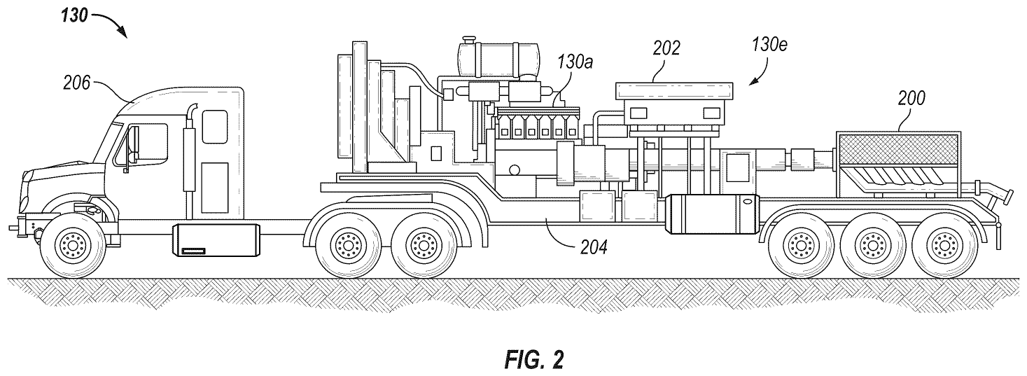

FIG. 2 illustrates an example pumping systems 130, according to aspects of the present disclosure. Pumping system 130 may be used, for instance, as one or more of pumping systems 130 described above with reference to FIG. 1. As depicted, pumping system 130 comprises a first mover 130 a in the form of a diesel engine coupled to reciprocating positive displacement pump 200 through a transmission system 202 into which an electric pump motor 130 e is integrated. First mover 130 a, reciprocating positive displacement pump 200, and transmission system 202 may be at least partially mounted on a trailer 204 coupled to a truck 206. Truck 206 may comprise, for instance, a conventional engine that provides locomotion to truck 206 and trailer 204 through a transmission system 202 incorporating an electric pump motor 130 e. Transmission system 202 may further comprise an electrical connection, such as a cable, between the transmission of truck 206 and electric pump motor 130 e in transmission system 202.

In use, truck 206 and trailer 204 with the pumping equipment mounted thereon may be driven to a well site at which a fracturing or other treatment operation will take place. In certain embodiments, truck 206 and trailer 204 may be one of many similar trucks and trailers that are driven to a well site. Once at the site, reciprocating positive displacement pump 200 may be fluidically coupled to a wellbore 150 (e.g., referring to FIG. 1), such as through a fluid manifold 140 (e.g., referring to FIG. 1), to provide treatment fluid to wellbore 150. Reciprocating positive displacement pump 200 may further be fluidically coupled to a source of treatment fluids to be pumped into the wellbore. When connected, the diesel engine may be started to provide a primary source of torque to reciprocating positive displacement pump 200 through transmission system 202. Electric pump motor 130 e in transmission system 202 similar may be engaged to provide a supplemental source of torque to reciprocating positive displacement pump 200. As depicted, electric pump motor 130 e in transmission system 202 may receive energy directly from the transmission of truck 206, such that truck 206 itself operates as an electrical generator for the pumping operation. In addition to energy from truck 206 and electric pump motor 130 e in transmission system 202, reciprocating positive displacement pump 200 may receive electricity from other energy sources on the site, including a dedicated electrical generator on site or other pumping systems located on the site. During frac operations 100, measurements may be performed to determine downhole properties or wellbore 150 and/or the formation. These measurements may be further processed by additional methods and systems that may utilize information handling system 190.

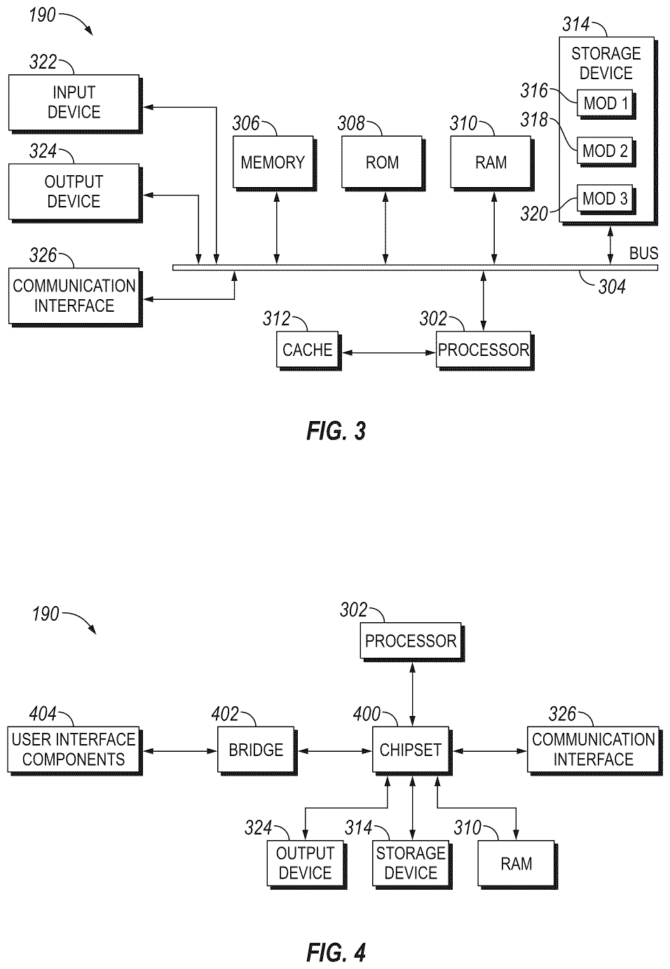

FIG. 3 further illustrates an example information handling system 190 which may be employed to perform various steps, methods, and techniques disclosed herein. Persons of ordinary skill in the art will readily appreciate that other system examples are possible. As illustrated, information handling system 190 comprises a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 190 may comprise a cache 312 of high-speed memory connected directly with, in close proximity to, or integrated as part of processor 302. Information handling system 190 copies data from memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. Memory 306 may comprise multiple different types of memory with different performance characteristics. It may be appreciated that the disclosure may operate on information handling system 190 with more than one processor 302 or on a group or cluster of computing devices networked together to provide greater processing capability. Processor 302 may comprise any general-purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may comprise multiple processors, such as a system having multiple, physically separate processors in different sockets, or a system having multiple processor cores on a single physical chip. Similarly, processor 302 may comprise multiple distributed processors located in multiple separate computing devices but working together such as via a communications network. Multiple processors or processor cores may share resources such as memory 306 or cache 312 or may operate using independent resources. Processor 302 may comprise one or more state machines, an application specific integrated circuit (ASIC), or a programmable gate array (PGA) including a field PGA (FPGA).

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 190, such as during start-up. Information handling system 190 further comprises storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may comprise software modules 316, 318, and 320 for controlling processor 302. Information handling system 190 may comprise other hardware or software modules. Storage device 314 is connected to the system bus 304 by a drive interface. The drives and the associated computer-readable storage devices provide nonvolatile storage of computer-readable instructions, data structures, program modules and other data for information handling system 190. In one aspect, a hardware module that performs a particular function comprises the software component stored in a tangible computer-readable storage device in connection with hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 190 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 190 employs storage device 314, which may be a hard disk or other types of computer-readable storage devices which may store data that are accessible by a computer, such as magnetic cassettes, flash memory cards, digital versatile disks (DVDs), cartridges, random-access memories (RAMs) 310, read only memory (ROM) 308, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 190, an input device 322 represents any number of input mechanisms, such as a microphone for speech, a touch-sensitive screen for gesture or graphical input, keyboard, mouse, motion input, speech and so forth. Additionally, input device 322 may receive one or more measurements from bottom-hole assembly 118 (e.g., referring to FIG. 1), discussed above. An output device 324 may also be one or more of a number of output mechanisms known to those of skill in the art. In some instances, multimodal systems enable a user to provide multiple types of input to communicate with information handling system 190. Communications interface 326 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general-purpose processor. For example, the functions of one or more processors presented in FIG. 3 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

FIG. 4 illustrates an example information handling system 190 having a chipset architecture that may be used in executing the described method and generating and displaying a graphical user interface (GUI). Information handling system 190 is an example of computer hardware, software, and firmware that may be used to implement the disclosed technology. Information handling system 190 may comprise a processor 302, representative of any number of physically and/or logically distinct resources capable of executing software, firmware, and hardware configured to perform identified computations. Processor 302 may communicate with a chipset 400 that may control input to and output from processor 302. In this example, chipset 400 outputs information to output device 324, such as a display, and may read and write information to storage device 314, which may comprise, for example, magnetic media, and solid-state media. Chipset 400 may also read data from and write data to RAM 310. A bridge 402 for interfacing with a variety of user interface components 404 may be provided for interfacing with chipset 400. Such user interface components 404 may comprise a keyboard, a microphone, touch detection and processing circuitry, a pointing device, such as a mouse, and so on. In general, inputs to information handling system 190 may come from any of a variety of sources, machine generated and/or human generated.

Chipset 400 may also interface with one or more communication interfaces 326 that may have different physical interfaces. Such communication interfaces may comprise interfaces for wired and wireless local area networks, for broadband wireless networks, as well as personal area networks. Some applications of the methods for generating, displaying, and using the GUI disclosed herein may comprise receiving ordered datasets over the physical interface or be generated by the machine itself by processor 302 analyzing data stored in storage device 314 or RAM 310. Further, information handling system 190 receives inputs from a user via user interface components 404 and executes appropriate functions, such as browsing functions by interpreting these inputs using processor 302.

In examples, information handling system 190 may also comprise tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may comprise RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be comprised within the scope of the computer-readable storage devices.

Computer-executable instructions comprise, for example, instructions and data which cause a general-purpose computer, special purpose computer, or special purpose processing device to perform a certain function or group of functions. Computer-executable instructions also comprise program modules that are executed by computers in stand-alone or network environments. Generally, program modules comprise routines, programs, components, data structures, objects, and the functions inherent in the design of special-purpose processors, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

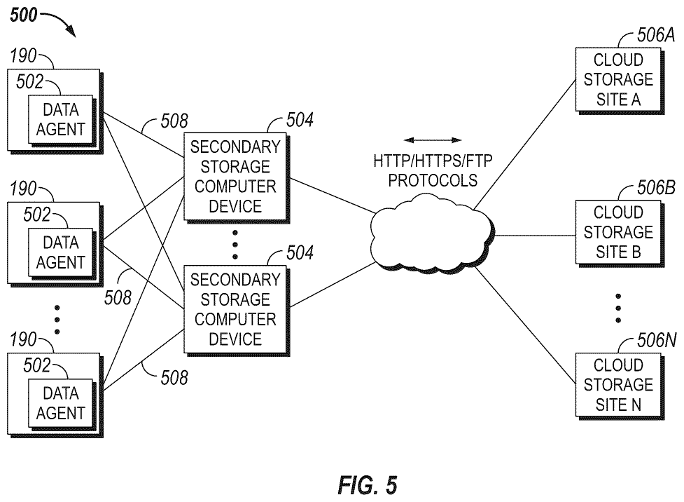

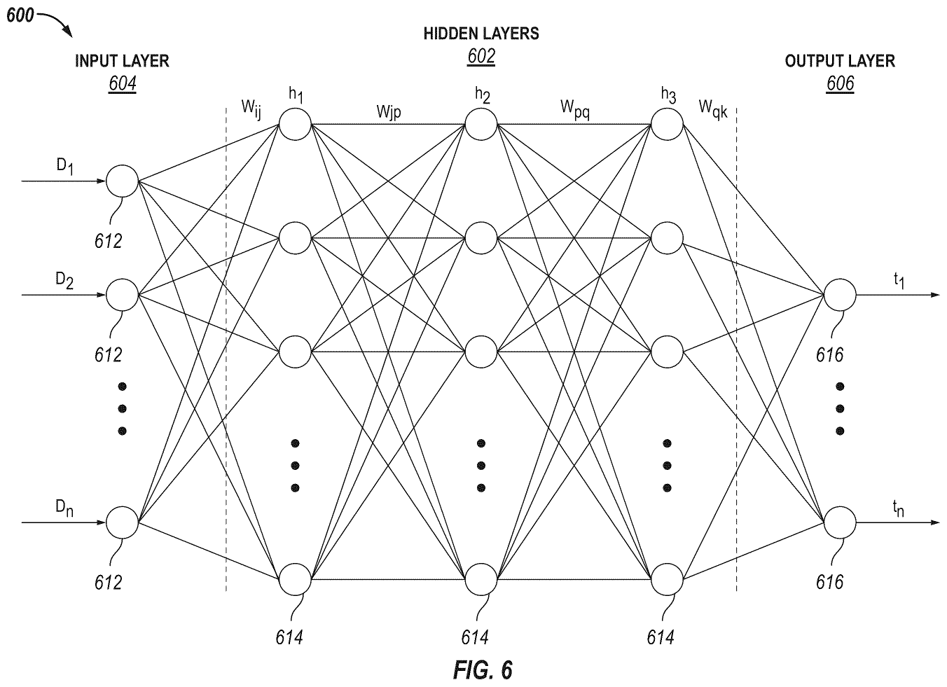

FIG. 5 illustrates an example of one arrangement of resources in a computing network 500 that may employ the processes and techniques described herein, although many others are of course possible. As noted above, an information handling system 190, as part of their function, may utilize data, which comprises files, directories, metadata (e.g., access control list (ACLS) creation/edit dates associated with the data, etc.), and other data objects. The data on the information handling system 190 is typically a primary copy (e.g., a production copy). During a copy, backup, archive or other storage operation, information handling system 190 may send a copy of some data objects (or some components thereof) to a secondary storage computing device 504 by utilizing one or more data agents 502.

A data agent 502 may be a desktop application, website application, or any software-based application that is run on information handling system 190. As illustrated, information handling system 190 may be disposed at any rig site (e.g., referring to FIG. 1), off site location, or repair and manufacturing center. The data agent may communicate with a secondary storage computing device 504 using communication protocol 508 in a wired or wireless system. Communication protocol 508 may function and operate as an input to a website application. In the website application, field data related to pre-and post-operations, generated DTCs, notes, and the like may be uploaded. Additionally, information handling system 190 may utilize communication protocol 508 to access processed measurements, operations with similar DTCs, troubleshooting findings, historical run data, and/or the like. This information is accessed from secondary storage computing device 504 by data agent 502, which is loaded on information handling system 190.

Secondary storage computing device 504 may operate and function to create secondary copies of primary data objects (or some components thereof) in various cloud storage sites 506A-N. Additionally, secondary storage computing device 504 may run determinative algorithms on data uploaded from one or more information handling systems 190, discussed further below. Communications between the secondary storage computing devices 504 and cloud storage sites 506A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 506A-N, the secondary storage computing device 504 may also perform local content indexing and/or local object-level, sub-object-level or block-level deduplication when performing storage operations involving various cloud storage sites 506A-N. Cloud storage sites 506A-N may further record and maintain, EM logs, map DTC codes, store repair and maintenance data, store operational data, and/or provide outputs from determinative algorithms that are located in cloud storage sites 506A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a component of a dataset for certain algorithms, not all algorithms require a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may comprise evaluating model performance according to whether the model is over-fit or under-fit. As it may be assumed that all datasets contain some level of error, it may be important to evaluate and optimize the model performance and associated model fit by a model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods comprise k-fold cross-validation, stratified k-fold cross-validation, bootstrapping, leave-one-out cross-validation, resubstituting, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may comprise the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may comprise whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset comprises both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may comprise Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not comprise a dependent variable as the intended function of this type of algorithm is to identify one or more groupings or clusters within a dataset. In a non-limiting example, algorithms which may be utilized for unsupervised machine learning may comprise K-means clustering, K-means classification, Fuzzy C-Means, Gaussian Mixture, Hidden Markov Model, Neural Networks, and Hierarchical algorithms.

In examples to determine a relationship using machine learning, a neural network (NN) 600, as illustrated in FIG. 6, may be utilized to determine properties of wellbore 150 (e.g., referring to FIG. 1) and/or the formation using measurements of the properties of electric pump motor 130 e (e.g., referring to FIG. 1). FIG. 6 illustrates neural network (NN) 600. NN 600 may operate utilizing one or more information handling systems 190 (e.g., referring to FIG. 1) on computing network 500. Although a NN is illustrated, multiple models may be used with input output structures. These models may comprise flexible empirical models such as NN, gaussian processing methods, kriging methods, evolutionary methods such as genetic algorithms, classification methods, clustering methods empirical methods, or physics-based methods such as equations of state, thermodynamic models, geological, geochemistry, or chemistry models, or kinetic models or any combinations therein including recursive combinations of similar or dissimilar models and iterative model combinations. A NN 600 is an artificial neural network with one or more hidden layers 602 between input layer 604 and output layer 606. In examples, NN 600 may be software on a single information handling system 190. In other examples, NN 600 may software running on multiple information handling systems 190 connected wirelessly and/or by a hard-wired connection in a network of multiple information handling systems 190. Herein, NN 600 may be applied in a wide array of implementations.

During operations, inputs 608 data are given to neurons 612 in input layer 604. Neurons 612, 614, and 616 are defined as individual or multiple information handling systems 190 connected in a computing network 500. The output from neurons 612 may be transferred to one or more neurons 614 within one or more hidden layers 602. Hidden layers 602 comprises one or more neurons 614 connected in a network that further process information from neurons 612. The number of hidden layers 602 and neurons 612 in hidden layer 602 may be determined by personnel that designs NN 600. Hidden layers 602 is defined as a set of information handling systems 190 assigned to specific processing. Hidden layers 602 spread computation to multiple neurons 612, which may allow for faster computing, processing, training, and learning by NN 600. Output from NN 600 may be computed by neurons 616. An information handling system 190 (e.g., referring to FIG. 1) being utilized in a computing network 500, NN 600, or alone may control frac operations 100. Specifically, measurements from electric pump motor 130 e of parameters of electric pump motor 130 e being used for a frac operation 100 may be measured and sent to information handling system 190 for further analysis. As discussed below, a tube wave, which may be generated at the end of frac operation 100 may be modeled.

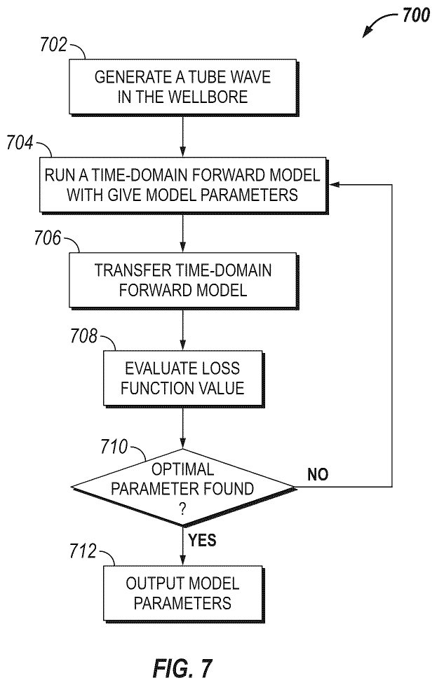

FIG. 7 illustrates a workflow 700 for modeling a tube wave. It should be noted that at least a part of workflow 700 may be performed on information handling system 190. Workflow 700 may begin with block 702. In block 702 a tube wave is generated withing tubing disposed within wellbore 150 (e.g., referring to FIG. 1). This may be performed by changing the flow rate in wellbore 150. Flow rate change may be created by ramping down electric pump motors 130 e. In other examples, the tube wave may also be generated by changing the flow rate of at least one pump, neutralizing all the pumps, opening or closing at least one of the surface valves. Methods discussed below may utilize flow rate and surface pressure measurements to properly align and scale the modeled tube wave and select the optimal parameters which maximize similarity between modeled and measured pressure signals. As discussed in detail, information handling system 190 may utilize the method below to reduce computation time.

At the end of a frac operation, a tub wave may be generated. It should be noted that “tube wave” may further be referred to as a “water hammer” or “pressure pulse.” The tube wave may be measured by at least one pressure transducer at surface that may be in fluid communication with wellbore 150. The tube wave measurement, as a pressure measurement, may be denoted as p(t). After a tube wave is generated in block 702, in block 704, using information handling system 190, a time-domain forward model with given model parameters may be created. The time-domain forward model created may be a mathematical process to simulate the (physical) temporal pressure response of pipe, that comprises a pipe system disposed in wellbore 150, to the excitation of the tube wave. Model parameters may be obtained mostly by various types of physical measurement, including pipe dimensions (length, diameters), fluid properties (compressibility, acoustic velocity, density etc), tube wave source's temporal signature, etc. The unknown resistance parameter R is also part of the parameters. Generally, in modelling and in an inversion, the value of R is given as an estimate to initiate the model and is updated through repeated modelling until an R value that reflects the resistance parameter is found, subject to some measurement metric. The time-domain forward model may be a numerical model simulating transient fluid dynamics. It may also be an analytical model describing transient fluid dynamics based on a Joukowsky equation and/or one or more wave equations. The time domain forward model may simulate tube waves under different parameters, denoted as:

$$\hat{p} ( t ) = f ( θ ; t ) \qquad ( 1 )$$

where θ is a set of model parameters and t is a simulation time. Model parameters θ may comprise a stage-level flow resistance R which describes the sensitivity of frictional loss of perforations to instantaneous flow rate into the perforations. Additionally, model parameters θ may also include a Darcy friction coefficient f_{D} of wellbore 150. In some embodiments, stage-level flow inductance L and flow capacitance C may be added. Subsurface condition evaluation may comprise wellbore friction based on f_{D}, a stage-level efficiency index which is a nonlinear function of R, and/or a fracture quality index based on L and C. In examples, t may be either continuous,

$$0 \leq t \leq {T}_{end} \qquad ( 2 )$$

where T_{end} is the end of simulation, or discrete values

$$t ∈ [ {t}_{1} , {t}_{2} , … , {t}_{{N}_{T}} ] \qquad ( 3 )$$

where N_{T} is the number of simulation steps.

During analysis of measurements by information handling system 190, it should be noted that the forward model does not depend on any measured data. The mechanism that creates the pulse wave, referred to as a source term, may not be utilized in the forward model. The “source term” is a variable that may represent the flow rate at the surface over time. In examples, the source term may be mathematically expressed

$$q ( x = 0 , t ) \qquad ( 4 )$$

The source term may be pre-determined based on the mechanism of generation, which generates the tube wave. For example, if a tube wave is generated by neutralizing all diesel pumps, the source term of the model may be assumed to be a step-down function with fixed amplitude, such as a Heaviside function with unit step.

The time-domain forward model, described above, may be performed before a tube wave is generated because the time-domain forward model is independent of measurements. For example, a list of all possible model parameters may be known (i.e., stored in a database) and/or created based on prior know-how. As soon as additional information such as wellbore casing inner diameter, measure depth of the stage, and/or the like are known, the time-domain forward model may be run with the list of possible model parameters on information handling system 190.

The time-domain forward model formed in block 704 may be transformed in block 706. The transformation may be an adaptive data-matching process. In block 706, the transformation is applied to the modeled tube wave that is expressed in Equation (1). The transformed modeled output is denoted as [symbol] (t). The purpose of transformation is to alter the model tube wave look to be similar in value to measured pressure wave p(t). In examples, the transformed model tube wave may be similar to the measured pressure wave by at least 95%, for the transformed model tube wave to be acceptable. Transform modeled pressure wave may involve a linear transformation, as shown:

$$( t ) = k \cdot \hat{p} ( t - {t}_{0} ) + b \qquad ( 5 )$$

where k is a scaling factor, b is a bias term, and t₀ is the time shift applied. The values of k, b and t₀ may be determined by a linear or nonlinear curve fitting algorithm. An additional term, k₂e^{-αt} may be added to Equation (5) to describe a slow pressure drop after a fracture closure. This additional term may further transform Equation (1) as a nonlinear transformation. However, given a time-domain forward model with nominal parameters, after the parameters of additional term (i.e., k₂ and α) are determined, k₂e^{-αt} may be subtracted from measured pressure wave p(t) such that in later iterations this term may no longer be needed. It should be noted that if nominal parameters are not available, a constant, a linear line, or any known curve as the output of “time-domain forward model with nominal parameters” may be utilized for determining the addition term, k₂e^{-αt}.

The transformed model from block 706 may be evaluated in block 708. Specifically in block 708 a loss function value is evaluated. For example, an optimal model parameter identified as θ* may be determined by varying θ in Eq. (1) and checking the value of a loss function which describes the mismatch between modeled and measured pressure waves. Specifically, the value of the loss function is check to determine if the value is small enough, subject to a pre-defined threshold, discussed above. If it is small enough, the value of the inverted parameter R is accepted for further use.

In block 710, the parameter R and its value may be used to estimate at least one subsurface condition or properties. The loss function may be in the form of sum of absolute errors (i.e., L1 norm), sum of squared errors (i.e., L2 norm) or Pearson correlation coefficient. Additionally, the loss function values may be compared with a predetermined threshold. In examples, the threshold may be a small value that is a percentage showing some relative difference. If it is above or below the threshold, the parameters may be defined as “optimal.” Alternatively, gradient of loss function numerically may be evaluated by checking the values of loss function of previous iterations. If the L2 norm of gradient is less than a threshold, parameters of current iteration may be considered “optimal.” Further, all possible model parameters (e.g., candidate model parameters, that may be evaluated by the model in Eq. (1)) may be evaluated and the parameters with the most/least loss function value may be selected. In block 712, the chosen parameters form block 712 may be identified as the output mode parameters. The output mode parameters may be used to evaluate the stage efficiency. Stage efficiency may refer to fracking efficiency at different stages of the fracking operation. Based at least in part on the stage efficiency, pumping rate may be adjusted, proppant concentration may be adjusted, and/or well completion design may be altered.

The methods and systems disclosed above may improve the computation speed of pressure pulse technology which uses measurements of a tube wave to diagnose subsurface conditions. Specifically, pre-computation of different forward models may be done once physical properties of the wellbore are known. Thus, modeling does not have to wait for frac operations to end. The measured data during or after the frac operation may be utilized with the pre-computations to find downhole properties without computing all variables at one time. This may allow the algorithm to be run on a field computer with limited computation resources.

Although the present disclosure and its advantages have been described in detail, it should be understood that various changes, substitutions and alterations may be made herein without departing from the spirit and scope of the disclosure as defined by the appended claims.
Statement 1: A method and system for evaluating one or more properties of a wellbore. The method may include generating a tube wave in a piping disposed in a wellbore, creating a time-domain forward model with one or more parameters to represent the tube wave in the piping, and transforming the time-domain forward model to model the tube wave as a pressure wave. The method may further include evaluating a loss function of the time-domain forward model and identifying a second set of parameters from the loss function to adjust the one or more parameters.
Statement 2: The method of statement 1, wherein the time-domain forward model is created before generating the tube wave.
Statement 3: The method of statements 1 or 2, wherein the time-domain forward model is a numerical model simulating a transient fluid dynamic.
Statement 4: The method of statement 3, wherein the transient fluid dynamic is based at least in part on a Joukowsky equation or one or more wave equations.
Statement 5: The method of any preceding statements 1, 2, or 3, wherein the transforming the time-domain forward model is performed by a linear transformation.
Statement 6: The method of any preceding statements 1-3, or 5, wherein the loss function is a sum of absolute errors, a sum of squared errors, or a Pearson correlation coefficient.
Statement 7: The method of any preceding statements 1-3, 5, or 6, further comprising comparing the loss function with a predetermined threshold.
Statement 8: The method of any preceding statements 1-3 or 5-7, further comprising comparing the loss function with one or more iterations of the loss function.
Statement 9: The method of any preceding statements 1-3 or 5-8, wherein the generating the tube wave is performed by changing a flow rate of at least one pump, neutralizing all pumps, opening one or more surface valves, or closing the one or more surface valves.
Statement 10: The method of any previous statements 1-3 or 5-9, wherein the second set of parameters identify a stage efficiency.
Statement 11: A system may comprise a plurality of pumps, wherein in one or more of the plurality of pumps may generate a tube wave in a piping disposed in a wellbore and an information handling system. The information handling system may be configured to create a time-domain forward model with one or more parameters to represent the tube wave in the piping, transform the time-domain forward model to model the tube wave as a pressure wave, evaluate a loss function of the time-domain forward model, and identify a second set of parameters from the loss function to adjust the one or more parameters.
Statement 12: The system of statement 11, wherein the time-domain forward model is created before generating the tube wave.
Statement 13: The system of statements 11 or 12, wherein the time-domain forward model is a numerical model simulating a transient fluid dynamic.
Statement 14: The system of statement 13, wherein the transient fluid dynamic is based at least in part on a Joukowsky equation or one or more wave equations.
Statement 15: The system of any previous statements 11-13, wherein the transform the time-domain forward model is performed by a linear transformation.
Statement 16: The system of any previous statements 11-13 or 15, wherein the loss function is a sum of absolute errors, a sum of squared errors, or a Pearson correlation coefficient.
Statement 17: The system of any previous statements 11-13, 15, or 16, wherein the information handling system is further configured to compare the loss function with a predetermined threshold.
Statement 18: The system of any previous statements 11-13 or 15-17, wherein the information handling system is further configured to compare the loss function with one or more iterations of the loss function.
Statement 19: The system of any previous statements 11-13 or 15-18, wherein the generate the tube wave is performed by changing a flow rate of at least one pump, neutralizing all pumps, opening one or more surface valves, or closing the one or more surface valves.
Statement 20: The system of any previous statements 11-13 or 15-19, wherein the second set of parameters identify a stage efficiency.

The preceding description provides various examples of the systems and methods of use disclosed herein which may contain different method steps and alternative combinations of components. It should be understood that although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
generating a tube wave in a piping disposed in a wellbore;
creating a time-domain forward model with one or more parameters to represent the tube wave in the piping;
transforming the time-domain forward model to model the tube wave as a pressure wave;
evaluating a loss function of the time-domain forward model; and
identifying a second set of parameters from the loss function to adjust the one or more parameters.

2. The method of claim 1, wherein the time-domain forward model is created before generating the tube wave.

3. The method of claim 1, wherein the time-domain forward model is a numerical model simulating a transient fluid dynamic.

4. The method of claim 3, wherein the transient fluid dynamic is based at least in part on a Joukowsky equation or one or more wave equations.

5. The method of claim 1, wherein the transforming the time-domain forward model is performed by a linear transformation.

6. The method of claim 1, wherein the loss function is a sum of absolute errors, a sum of squared errors, or a Pearson correlation coefficient.

7. The method of claim 1, further comprising comparing the loss function with a predetermined threshold.

8. The method of claim 1, further comprising comparing the loss function with one or more iterations of the loss function.

9. The method of claim 1, wherein the generating the tube wave is performed by changing a flow rate of at least one pump, neutralizing all pumps, opening one or more surface valves, or closing the one or more surface valves.

10. The method of claim 1, wherein the second set of parameters identify a stage efficiency.

11. A system comprising:
a plurality of pumps, wherein in one or more of the plurality of pumps may generate a tube wave in a piping disposed in a wellbore; and
an information handling system configured to:
create a time-domain forward model with one or more parameters to represent the tube wave in the piping;
transform the time-domain forward model to model the tube wave as a pressure wave;
evaluate a loss function of the time-domain forward model; and
identify a second set of parameters from the loss function to adjust the one or more parameters.

12. The system of claim 11, wherein the time-domain forward model is created before generating the tube wave.

13. The system of claim 11, wherein the time-domain forward model is a numerical model simulating a transient fluid dynamic.

14. The system of claim 13, wherein the transient fluid dynamic is based at least in part on a Joukowsky equation or one or more wave equations.

15. The system of claim 11, wherein the transform the time-domain forward model is performed by a linear transformation.

16. The system of claim 11, wherein the loss function is a sum of absolute errors, a sum of squared errors, or a Pearson correlation coefficient.

17. The system of claim 11, wherein the information handling system is further configured to compare the loss function with a predetermined threshold.

18. The system of claim 11, wherein the information handling system is further configured to compare the loss function with one or more iterations of the loss function.

19. The system of claim 11, wherein the generate the tube wave is performed by changing a flow rate of at least one pump, neutralizing all pumps, opening one or more surface valves, or closing the one or more surface valves.

20. The system of claim 11, wherein the second set of parameters identify a stage efficiency.
